(19) United States
(12) Patent Application Publication
(10) Pub. No.: US 2020/0001566 A1
(43) Pub. Date: Jan. 2, 2020

(54) INTEGRAL SPACER FABRICS PROVIDED WITH ADAPTIVE THICKNESS AND METHOD OF FABRICATING THE SAME

(71) Applicant: Mackent Fabrics Co., Ltd., Taoyuan City (TW)

(72) Inventors: Yi-Chen Lin, Taoyuan City (TW); Chang-Chi Wang, Taoyuan City (TW)

(21) Appl. No.: 16/458,937

(22) Filed: Jul. 1, 2019

Related U.S. Application Data
(60) Provisional application No. 62/692,025, filed on Jun. 29, 2018.

(51) Int. Cl. B32B 3/26; D04B 21/16; B32B 5/26; B32B 5/02

(52) U.S. Cl. CPC B32B 3/263; D04B 21/16; B32B 5/26; B32B 2437/00; D10B 2403/021; D10B 2331/10; B32B 5/026

(57) ABSTRACT

An integral spacer fabric provided with adaptive thickness and a method of fabricating the same are provided. The spacer fabric includes a first fabric layer and a second fabric layer and a central fabric layer which is intertwined with the first fabric layer and the second fabric layer and formed of a plurality of wave-like fibers. The central fabric layer is formed with adaptive thicknesses in accordance with a predetermined thickness pattern by means of a flat knitting machine.

This non-provisional utility patent application claims the benefit of a prior-filed co-pending application; a reference to the prior application is identified as the relationship of the applications and application number (series code/serial number) as follows: the present application is filed as a non-provisional and claims the priority filing date and benefit based upon the following provisional patent applications: Ser. No. 62/692,025 filed Jun. 29, 2018, which are incorporated herein by reference in their entirety.

### BACKGROUND OF THE INVENTION

### 1. Technical Field

The present invention relates to spacer fabrics and, more particularly, to integral spacer fabrics provided with adaptive thickness and method of fabricating the same.

### 2. Description of Related Art

Spacer fabric is a three-dimensional knitted fabric consisting of one hydrophilic fiber layer and one hygroscopic fabric layer which are separate knitted and joined together by spacer yarns. The spacer yarns can be made of monofilarnent or multi-filament yarns. Such a three-layer structure makes the spacer fabric also known as “sandwich fabric.” The spacer fabrics are thus characterized as permeability to moisture and heat and widely applied to make brasseries, underwear, sportswear or the like.

The conventional spacer fabrics are usually uniform in thickness. The inventors come up with a proposal to vary its thickness while knitting spacer fabrics in consideration of variable functions of the garment to be made. In other words, an integral spacer fabric provided with adaptive thickness can save the labor costs and time for subsequent processing if it can be realized and implemented.

### SUMMARY OF THE INVENTION

It is, therefore, an object of this invention to provide an integral spacer fabric provided with adaptive thickness and a method of fabricating the same. The integral spacer fabric in accordance with the present invention varies its thickness while knitting in consideration of variable functions of the garments to be made so as to save labor costs and time for subsequent processing,

Accordingly, one embodiment of the present invention provides an integral spacer fabric provided with adaptive thickness. The spacer fabric includes a first fabric layer and a second fabric layer and a central fabric layer which is intertwined with the first fabric layer and the second fabric layer and formed of a plurality of wave-like fibers. The central fabric layer is formed with adaptive thicknesses in accordance with a predetermined thickness pattern by means of a flat knitting machine.

Another embodiment of the present invention provides a method of fabricating an integral spacer fabric provided with adaptive thickness. According to the method of the present invention, a predetermined thickness pattern is first formed and provided. Next, the spacer fabric is formed in accordance with the predetermined thickness pattern by means of a flat knitting machine. The spacer fabric comprises a first fabric layer, a second fabric layer and a central fabric layer which is intertwined with the first fabric layer and the second fabric layer and is formed of a plurality of wave-like fibers. The central fabric layer is formed with adaptive thicknesses in accordance with the predetermined thickness pattern.

### BRIEF DESCRIPTION OF THE DRAWINGS

The structure and advantages of the present invention be best understood by referring to the following detailed description of an illustrative embodiment in conjunction with the accompanying drawings, in which:

FIG. 1 is a perspective view schematically showing a spacer fabric;

FIG. 2 is a schematic view showing an example of the integral spacer fabric in accordance with a preferred embodiment of the present invention; and

FIG. 3 is a partial view of a flat knitting machine employed to make the integral spacer fabric in accordance with the present invention.

### DETAILED DESCRIPTION OF THE INVENTION

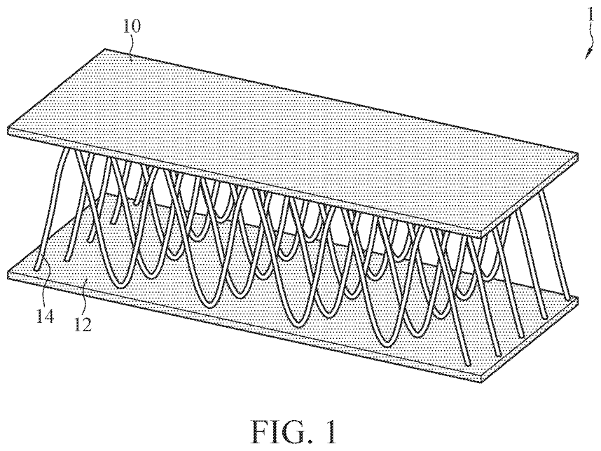

Referring to FIG. 1 a perspective view schematically shows a spacer fabric. The spacer fabric 1 of the present invention includes an outer fabric layer 10, an inner fabric layer 12 and a central fabric layer 14. The central fabric layer 14 is interposed between the outer fabric layer 10 and the inner fabric layer 12. The central fabric layer 14 consists of a plurality of wave-like fibers. The crests of the wave-like fibers are intertwined with the outer fabric layer 10. The troughs of the wave-like fibers are intertwined with the inner fabric layer 12. It is noted that the words “crests” and “troughs” are employed to describe the spatial relationship of the outer and inner fabric layers 10 and 12 as illustrated in FIG. 1; however, they cannot be construed to limit the scope of the present invention.

Preferably, the outer fabric layer 10 can be knitted with a material selected from a group consisting of PET (polyethylene terephthalate), polyester, nylon, PU (polyurethane) or the like and any combination thereof. Preferably, the outer fabric layer can be made with jacquard or embossing/printing patterns. Furthermore, the central fabric layer 14 can be knitted with monofilament fibers or multifilament fibers made of a material selected from a group consisting of PET (polyethylene terephthalate), polyester, nylon, PU (polyurethane) or the like and any combination thereof. The inner fabric layer 12 can be substantially knitted with a material selected from a group consisting of PET (polyethylene terephthalate), polyester, nylon, PU (polyurethane) or the like and any combination thereof. If it is intended to be sticky to wearers' skin, the inner fabric layer 12 can be preferably made of nylon, spandex, PU or any material provided with intrinsic stickiness.

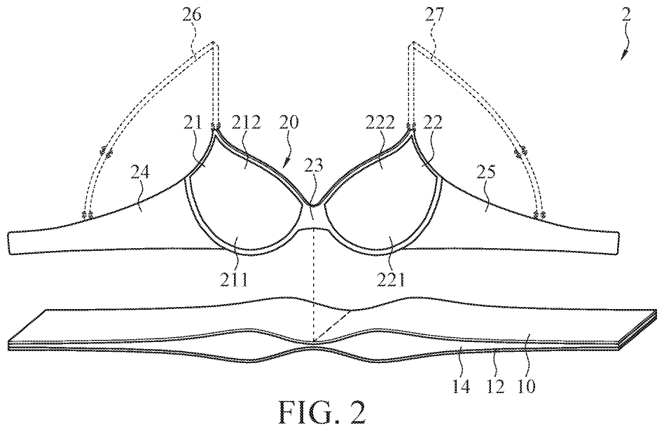

According to the present invention, the functional requirements of the garments to be made of the spacer fabric are predetermined and considered to vary with different thicknesses, that is so-called “adaptive thickness” in this application while manufacturing the spacer fabric. In FIG. 2, is a schematic view showing an example of the integral spacer fabric in accordance with one preferred embodiment of the present invention. As shown in FIG. 2, a female brassiere 2 is exemplified in this embodiment.

As illustrated in FIG. 2, the brassiere 2 is made of an integral spacer fabric in accordance with the present invention. The brassiere 2 includes two bra cups 21 and 22 connected via a connecting portion 23. Two wings 24 and 25 are respectively extended from the outer edges of the bra cups 21 and 22. The reference numeral 26 designates one shoulder strap in connection with the cup 21 and the wing 24. The reference numeral 27 designates the other shoulder strap in connection with the cup 22 and the wing 25.

According to the present invention, the bra cups 21 and 22, the connecting portion 23 and the wings 24 and 25 are all formed of the same integral spacer fabric 1. As shown in FIG. 2, the bra cup 21 is provided with a push-up part 211 and an upper part 212. The push-up part 211 is the proximate laterally outer area of the bra cup 21, and the upper part 212 approximates the middle and inner area of the bra cups 21. Similarly, the bra cup 22 is provided with a push-up part 221 and an upper part 222. The push-up part 221 is the proximate laterally outer area of the cup 22, and the upper part 222 approximates the middle and inner area of the bra cup 22. The bra cups 21 and 22 are designed to enclose and hold the breast tissue of a brassiere wearer and to help shape the wearer's breasts. Generally speaking, the thickness of the spacer fabric 1 in the push-up parts 211 and 221 is greater than the thickness of the spacer fabric 1 in the upper parts 221 and 222 so as to provide better breast-supporting capability. Preferably, the thickness of the spacer fabric 1 in the bra cup 21 is gradually decreased from the push-up part 211 to the upper part 212, the thickness of the spacer fabric 1 in the bra cup 22 is gradually decreased from the push-up part 221 to the upper part 222,

Further referring to FIG. 2, the thickness of the spacer fabric 1 in the push-up part 211 is greater than the thickness of the spacer fabric 1 in the wing 24. Preferably; the thickness of the spacer fabric 1 in the wing 24 is gradually decreased from one end of the wing 24, which is near the outer edge of the bra cup 21, to the other end of the wing 24, which is far away from the bra cup 21. Similarly, the thickness of the spacer fabric 1 in the push-up part 221 is greater than the thickness of the spacer fabric 1 in the wing 25. Preferably, the thickness of the spacer fabric 1 in the wing 25 is gradually decreased from one end of the wing 25, which is near the outer edge of the bra cup 22, to the other end of the wing 25 which is far away from the bra cup 22.

As exemplified in the brassiere 2 of FIG. 2, the outline pattern 20 of the brassiere should be predetermined before fabricating the integral spacer fabric 1. For the bra cup 21, the thickness of the spacer fabric 1 in the push-up part 211 is greater than the thickness of the spacer fabric 1 in the upper part 212. The thickness of the spacer fabric 1 in the push-up part 211 is greater than the thickness of the spacer fabric 1 in the wing 24. For the bra cup 22, the thickness of the spacer fabric 1 in the push-up part 221 is greater than the thickness of the spacer fabric 1 in the upper part 222. The thickness of the spacer fabric 1 in the push-up part 221 is greater than the thickness of the spacer fabric 1 in the wing 25. Based upon those thickness requirements and the outline pattern as above, a computer-controlled knitting machine can be employed to manufacture the specific spacer fabric 1 to adaptively adjust the corresponding thicknesses in different parts. As shown in the lower part of FIG. 2, the thicknesses alone with the wing 24, the push-up part 211 of the bra cup 21, the upper part 212 of the bra cup 21, the connecting part 23, the upper part 222 of the bra cup 22, the push-up part 221 of the bra cup 22 and the wing 25 are adaptively varied in a cross-sectional view, from left to right.

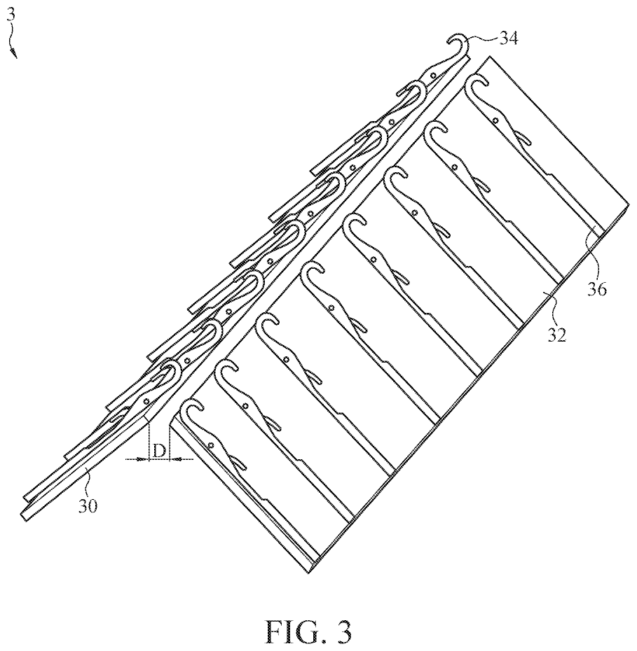

According to the present invention, the flat knitting machine is employed to manufacture the integral spacer fabric provided with adaptive thicknesses. Referring to FIG. 3, a partial view of the flat knitting machine applied to the make the integral spacer fabric 1 in accordance with the present invention is illustrated. In FIG. 3, a partial V-shape needle bed, or V-bed in simple, includes two needle beds 30 and 32 which are arranged in inverse-V shape and spaced apart by a top distance D. The needle bed 30 includes one row of needles 34 and the needle bed 32 includes the other row of needles 36. The needles 34 and needles 36 are deposed and arranged alternately. When the V-bed flat knitting machine is applied to manufacture the integral spacer fabric 1 as shown in FIG. 2, the computer is utilized to adaptively control the top distance D in order to vary the thickness of the central fabric layer 14 given the outline pattern 20 and the variable thickness requirements. The greater the top distance D of the V-bed flat knitting machine 3, the thicker the central fabric layer of the spacer fabric 1. On the other hand, the smaller the top distance D of the V-bed flat knitting machine 3, the thinner the central fabric layer 14 of the spacer fabric 1. In a word, the top distance D of the V-bed flat knitting machine 3 can be controlled by the computer to adaptively adjust the thickness of the central fabric layer 14 as required and produce the integral spacer fabric 1 provided with adaptive thicknesses.

Moreover, the present invention discloses a method of fabricating the integral spacer fabric provided with adaptive thickness. First of all, a product pattern should be predetermined prior to fabricate the integral spacer fabric 1. As exemplified in the brassiere 2 of FIG. 2, the outline pattern 20 of the brassiere 2 should be predetermined prior to manufacture the spacer fabric 1. For the bra cup 21, the thickness of the spacer fabric 1 in the push-up part 211 is greater than the thickness of the spacer fabric 1 in the upper part 212. The thickness of the spacer fabric 1 in the push-up part 211 is greater than the thickness of the spacer fabric 1 in the wing 24. For the bra cup 22, the thickness of the spacer fabric 1 in the push-up part 221 is greater than the thickness of the spacer fabric 1 in the upper part 222. The thickness of the spacer fabric 1 in the push-up part 221 is greater than the thickness of the spacer fabric 1 in the wing 25. The outline pattern and thickness requirements are collected together as “predetermined thickness patterns,” all of which are provided as parameters input for further processing by the computer. The computer is then utilized to control the needle beds of the flat knitting machine 3 as shown in FIG. 3. As mentioned above, the computer variably controls the top distance D of two spaced needle beds 30 and 32 to adaptively adjust the thickness of the central fabric layer 14 and make the integral spacer fabric 1 provided with adaptive thicknesses eventually.

According to the present invention, the integral spacer fabric provided with adaptive thickness and the method of fabricating the same can save labor costs, time and efforts for subsequent processing. Though the brassiere 2 is exemplified in FIG. 2, the integral spacer fabric can be similarly and widely applied to fabricate bra pads, nipple covers, pasties, paddings, shaping garments, sportswear or the like.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A spacer fabric, comprising:
a first fabric layer and a second fabric layer, both made of yarns, and
a central fabric layer intertwined with said first fabric layer and said second fabric layer and formed of a plurality of wave-like fibers;
wherein said central fabric layer is formed with adaptive thicknesses in accordance with a predetermined thickness pattern by means of a flat knitting machine.

2. The spacer fabric as claimed in claim 1, wherein a portion of said central fabric layer is thicker to provide better push-up effects.

3. The spacer fabric as claimed in claim 1, wherein said second fabric layer includes a material which is selected from the group consisting of spandex, polyurethane, and nylon and is in close contact with the skin of a wearer of said spacer fabric.

4. The spacer fabrics as claimed in claim 1, wherein jacquard, embossing, printing patterns or a combination thereof is formed on said first fabric layer.

5. A method of fabricating a spacer fabric, comprising the following steps of:
providing a predetermined thickness pattern; and
forming a spacer fabric in accordance with said predetermined thickness pattern by means of a flat knitting machine;
wherein said spacer fabric comprises a first fabric layer, a second fabric layer and a central fabric layer which is intertwined with said first fabric layer and said second fabric layer and is formed of a plurality of wave-like fibers;
wherein said central fabric layer is formed with adaptive thicknesses in accordance with said predetermined thickness pattern.

6. The method as claimed in claim 5, wherein a portion of said central fabric layer is thicker to provide better push-up effects.

7. The method as claimed in claim 5, wherein said second fabric layer includes a material which is selected from the group consisting of spandex, polyurethane, and nylon and is in close contact with the skin of a wearer of said spacer fabric.

8. The method as claimed in claim 5, further comprising the step of forming jacquard, embossing, printing patterns or a combination thereof on said first fabric layer.
